(19) United States
(12) Patent Application Publication
(10) Pub. No.: US 2011/0179281 A1
(43) Pub. Date: Jul. 21, 2011

(54) HASH FUNCTION USING A QUASI-GROUP OPERATION

(75) Inventors: Benoit CHEVALLIER-MAMES, Paris (FR); Mathieu Ciet, Paris (FR); Augustin J. Farrugia, Cupertino, CA (US)

(73) Assignee: Apple Inc., Cupertino, CA (US)

(21) Appl. No.: 12/690,740

(22) Filed: Jan. 20, 2010

(51) Int. Cl. H04L 9/32

(52) U.S. Cl. 713/181

(57) ABSTRACT

In the computer data security field, a cryptographic hash function process is embodied in a computer system or computer software or logic circuitry and is keyless, but highly secure. The process is based on (mathematical) quasi-group operations such as in the known “EDON-R” hash function. But here one or more blank rounds (iterations) of the quasi-group operation are concatenated to the EDON-R hash function operations, to overcome perceived security weaknesses in EDON-R.

### FIELD OF THE INVENTION

This invention relates to computing, communications, data security, and hash functions (hashing).

### BACKGROUND

Hash functions are well known in the field of data security. The principle is to take data (a digital message, digital signature, etc.) and use it as an entry to a hash function resulting in an output called a “digest” of predetermined length which is intended to uniquely identify (“fingerprint”) the message. A secure (cryptographic) hash is such that any alteration in the message results in a different digest, even though the digest is much shorter than the message. Such hash functions are “collision-resistant” and “one-way” examples of a compression function.

Cryptography and data security deal with digital signatures, encryption, document authentication, and hashing. In all of these fields, there is a set of basic tools/functions which are widely used, for instance hash functions. Several properties are required for the use of hash functions in cryptographic applications: preimage resistance, second preimage resistance and collision resistance.

In the recent years, much energy has been expended finding new hash functions, since collisions (weaknesses or successful attacks) have been found in the widely used SHA-0/1 and MD5 standard hash functions. After this security crisis involving MD5 and SHA-0/1, two hash function standards used for a long time without concern for their security, the U.S. NIST (National Institute of Standard and Technology) launched an international competition to define the new standard for hash functions. The competition started in 2008. Amongst the competitors, many were broken easily, since the submitters were not really aware of the cryptographic issues. Of the remaining submissions, one called “EDON-R” was advantageously one of the computationally fastest. Unfortunately, it was not selected for Round 2 of the competition, because some cryptanalytic attacks have been mounted against it.

### SUMMARY

Disclosed here is a cryptographic (secure) hash function or process. The goal is a highly modular hash function that is also computationally efficient. The present hash function can conventionally be used for document integrity for exchanges and signatures. It can be also used as a derivation function or as a HMAC (hash message authentication code) by adding a key conventionally (as in for instance the well known HMAC-SHA1) and the term “hash” as used herein is intended to encompass all these uses, both keyed and non-keyed.

A hash function is a deterministic procedure that accepts an arbitrary length input value, and returns a hash value of fixed or defined size. The input value is called the message, and the resulting output hash value is called the digest. The message is authenticated by comparing the computed digest to an expected digest associated with the message.

In one embodiment, the present hash function is a modification to the known hash function EDON-R, in order to circumvent the weaknesses found in the various attacks mentioned above.

The present modifications do not decrease performance much but improve the security from a cryptanalysis point of view. Furthermore, some embodiments do not change the EDON-R design, but only add steps, so as to profit from the security claims and knowledge about EDON-R.

### BRIEF DESCRIPTION OF THE FIGURES

FIG. 1 depicts graphically a known quasi-group hash function as in EDON-R.

FIG. 2 depicts graphically the present hash function.

FIG. 3 shows relevant portions of a computing apparatus for carrying out the present method.

FIG. 4 shows additional detail of the FIG. 2 computing apparatus.

### DETAILED DESCRIPTION

This disclosure first describes the known EDON-R hash function, and then the present modifications. For more information about the original EDON-R hash function, see the original published documentation, available on the NIST server (http://csrc.nist.gov/groups/ST/hash/sha-3/Round1/documents/EDON-R.zip), including a document entitled “Cryptographic Hash Function EDON-R” by Danilo Gligoroski.

EDON-R can be defined as follows (with a digest size designated h, e.g. h=256 bits) in terms of four main steps:

1. Pad the input message (data) m. This transforms m, a (plain text) message, which is a given chain of bits, into M, that can be divided (partitioned) into an exact integral number N of equal length blocks {M_i} numbered from 1 to N, by conventional bit padding e.g., of length 512 or 1024 bits according to the version. In EDON-R the padding technique is defined as adding at least 65 bits.
2. Initialize a state designated st to an initial value st0.
3. For i=1 to N (each block i), compute

st=R(st,M_{—}i)xorstxorM_{—}i

where R designates the defined quasi-group internal permutation (operation) of EDON-R having two inputs, and “xor” is the Boolean exclusive OR operator.
4. The hash value (digest) is selected from state st, such as the last h bits of the state st. This truncation step is designated T.

For more simplicity, the following is for the case h=256. The internal permutation (operation) R of EDON-R is based on a quasi-group operation of order 2²⁵⁶. To cite the original EDON-R documentation:
A quasi-group (Q₁*) is an algebraic structure consisting of a nonempty set Q and a binary operation *: Q2→Q with the property that each of the equations

a*x=b

y*a=b
has unique solutions x and y in Q.

In more detail, EDON-R is characterized as a family of hash functions, each being an iterative Merkle-Damgard hash function. The digest length of EDON-R is specified as one of 256, 224, 256, 384 or 512 bits. The R operation is a “double pipe.” Step 2 initializes the state of this double pipe as shown below.

In EDON-R for h=256, the quasi-group operation R of order 2²⁵⁶ is described logically as follows:

INPUT: (X0,X1,...,X7), (Y0,Y1,...,Y7)
OUTPUT: (Z0,Z1,...,Z7)
TEMPORARY VARIABLES: (T0,T1,...,T7)
OPERATION R( ):
T0 <- ROT_LEFT_0 (0xAAAAAAAA + X0 + X1 + X2 + X4 + X7 );
T1 <- ROT_LEFT_4 ( X0 + x1 + X3 + X4 + X7 );
T2 <- ROT_LEFT_8 ( X0 + X1 + X4 + X6 + X7 );
T3 <- ROT_LEFT_13 ( X2 + X3 + X5 + X6 + X7 );
T4 <- ROT_LEFT_17 ( X1 + X2 + X3 + X5 + X6 );
T5 <- ROT_LEFT_22 ( X0 + X2 + X3 + X4 + X5 );
T6 <- ROT_LEFT_24 ( X0 + X1 + XS + X6 + X7 );
T7 <- ROT_LEFT_29 ( X2 + X3 + X4 + X5 + X6 );
T8 <- T3 xor T5 xor T6 ;
T9 <- T2 xor T5 xor T6 ;
T10 <- T2 xor T3 xor T5 ;
T11 <- T0 xor T1 xor T4 ;
T12 <- T0 xor T4 xor T7 ;
T13 <- T1 xor T6 xor T7 ;
T14 <- T2 xor T3 xor T4 ;
T15 <- T0 xor T1 xor T7 ;
T0 <- ROT_LEFT_0 (0x55555555 + Y0 + Y1 + Y2 + Y5 + Y7 );
T1 <- ROT_LEFT_5 ( Y0 + Y1 + Y3 + Y4 + Y6 );
T2 <- ROT_LEFT_9 ( Y0 + Y1 + Y2 + Y3 + Y5 );
T3 <- ROT_LEFT_11 ( Y2 + Y3 + Y4 + Y6 + Y7 );
T4 <- ROT_LEFT_15 ( Y0 + Y1 + Y3 + Y4 + Y5 );
T5 <- ROT_LEFT_20 ( Y2 + Y4 + Y5 + Y6 + T7 );
T6 <- ROT_LEFT_25 ( Y1 + Y2 + Y5 + Y6 + Y7 );
T7 <- ROT_LEFT_27 ( Y0 + Y3 + Y4 + Y6 + Y7 );
Z5 <- T8 + ( T3 xor T4 xor T6 );
Z6 <- T9 + ( T2 xor T5 xor T7 );
Z7 <- T10 + ( T4 xor T6 xor T7 );
Z0 <- T11 + ( T0 xor T1 xor T5 );
Z1 <- T12 + ( T2 xor T6 xor T7 );
Z2 <- T13 + ( T0 xor T1 xor T3 );
Z3 <- T14 + ( T0 xor T3 xor T4 );
Z4 <- T15 + ( T1 xor T2 xor T5 );

where ROT_LEFT_i stands for a conventional bit rotation of i bits to the left. (Note that T0, T1, etc. are the temporary variables and not the truncation function T.) The addition operation “+” here is modulo 2³². EDON-R like most modern hash functions is typically embodied in computer code (software) to be executed on a processor or may be embodied in equivalent logic circuitry.

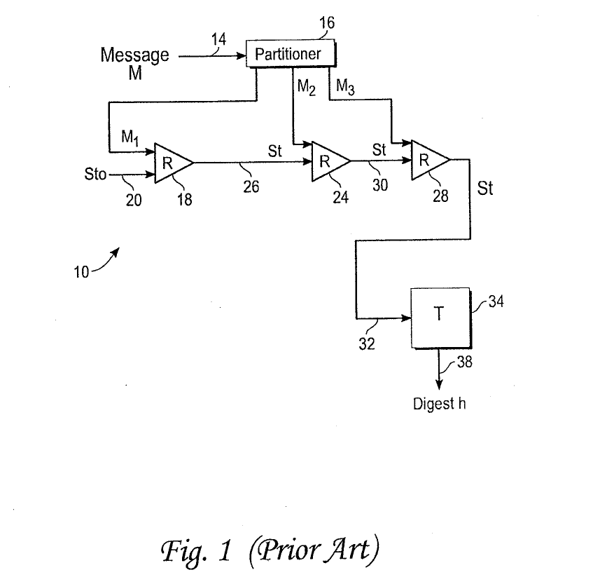

Graphically, EDON-R can be represented as process 10 shown in FIG. 1. The plain text message m is provided at port 14 to the padding and partitioning logic 16 which outputs N successive message blocks each designated Mi to the R operation logic element depicted at 18, 24, and 30 (the single R operation is depicted multiple times here only for purposes of illustration.) Since these are identical, there is usually only one R operation in the relevant computer code, which is conventionally called multiple times. The initial state value designated st0 is input at port 20 to the first call to the R operation 18, the second input thereto being message block M1 (these two inputs are respectively designated X and Y above). Similarly the output st (designated Z above) of the first R operation 18 is input to the second R operation 24 at port 26, along with message block M2. The third R operation 28 has as its inputs the output st from R operation 24 at port 30, and message block M3. The output st of R operation 28 is coupled at port 32 to the truncation logic T 34 which extracts therefrom and outputs the digest at its output port 38.

EDON-R has suffered from a number of at least partly successful attacks or cryptanalysis, notably those shown in the following publications (all available on the world wide web): Dmitry Khovratovich, Ivica Nikolic, Ralf-Philipp Welnmann “Cryptanalysis of Edon-R”; Vlastimil Klima “Multicollisions of EDON-R hash function and other observations”; Danilo Gligoroski, Rune Steinsmo Ødegard “On the Complexity of Khovratovich et. al's Preimage Attack on EDONR”; Gaëtan Leurent “Key Recovery Attack against Secret-prefix Edon-R”; and Peter Novotney, Niels Ferguson “Detectable correlations in Edon-R”.

The present inventors have determined that these attacks exploit that at the end, the truncation (selection) step T (i.e., step 4 of EDON-R) allows the attacker to obtain information about the message block entry (input) of the last call to the R operation. Since the R operation is far from being a perfect permutation (as shown and used in the above attacks), this partial knowledge of the entry of the last call to the R operation allows mounting an attack.

The present modification to EDON-R adds one or more blank rounds after completion of all the R operations on the message blocks. This modified hash function is as follows:

1. Pad the plain text input message (data) m. This transforms message m, a given chain of bits, into M, a plain text message that can be divided (partitioned) into an exact integral number N of blocks {M_i} by padding as in EDON-R above.
2. Initialize the state st to an initial value st0 as in EDON-R.
3. For i=1 to N, compute

st=R(st,M_{—}i)xorstxorM_{—}i

where R is the same operation as in EDON-R.
4. For i=1 to S, compute

st=R(st,st)

5. The hash value is selected as, e.g., the last h bits of the state st.

Step 4 is new and provides a security parameter designated S. In step 4, the hash function loops to perform several (as defined by S) R operation loops, but instead of using a new message block as one of the entries to each R operation as in EDON-R, the previous value of the state st itself is used as both the inputs.

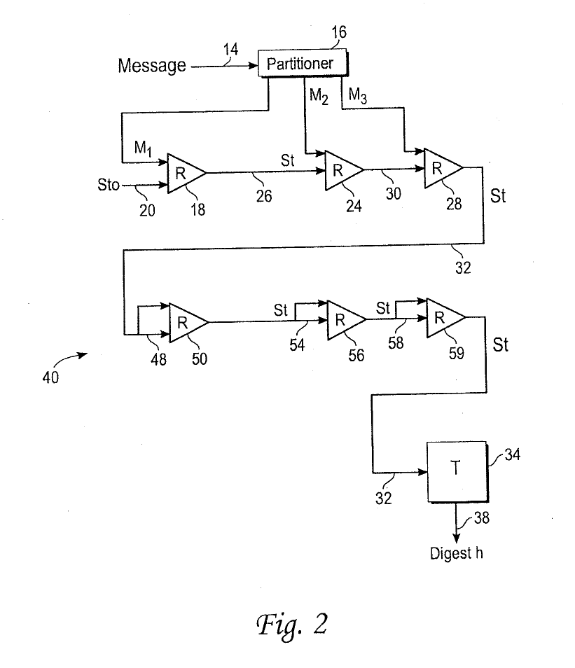

Graphically this process 40 is shown in FIG. 2, with in this example S=3 blank rounds of operation R. (Blank rounds are known generally in cryptography. They are provided to make computations without any associated control after the last message block has been used.) Process 40 of FIG. 2 is largely similar to process 10 of FIG. 1, but with the three added blank rounds using operation R depicted at 50, 56, and 59. For blank round 50, the two inputs at port 48 are each identically the output st from R operation 28 at output port 32. The same is true of the second blank round 56, where the two inputs are each the output st from the previous R operation 50 at port 54. The third blank round 59 has the same structure, with its inputs being the output st from the previous R operation 56 at port 58.

The strength of this hash function is that, even if operation T is weak, in the sense it gives an idea of the output of the last R operation, this cannot be used for an attack, since neither entry (input) of this last R operation is known to the attacker (who is presumably using a known plain text attack). On the contrary, in EDON-R, one of these two inputs is known; it is the last (plain text) message block M_{N}.

While the above exemplary embodiment largely conforms to EDON-R for the practical reasons given above, the present invention is not so limited. In other embodiments, parameters such as h (the number of output bits in the digest), the number of blank round R operations, S, the initialization values, and even the internal structure of the R operation in the message rounds and/or blank rounds may be changed. Hence the present invention includes applying a quasi-group operator (of which the EDON-R R operation is an example) to successive portions of a padded message (the input data), followed by application of at least one blank round of a quasi-group operator, then the function (selection) step to extract the digest.

Further, the blank rounds need not be the identical quasi-group operation as applied to the message blocks. Further, the inputs to each of the blank rounds need not be exactly the result (state) of the previous operation (round) but may be further modified, such as the result (state) of the previous operation output plus a constant value. In other modifications, one may also use states appearing in the past (i.e., previous blocks), as simple permutations of the state (e.g., one switches bits of previous states from one place to another). In general, any embodiment where the attacker has no control and where the attacker does not know the values used is contemplated.

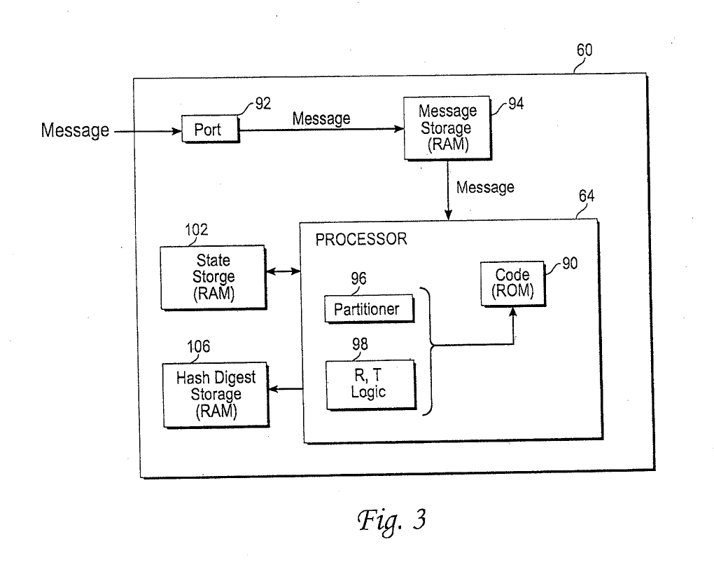

FIG. 3 shows in a block diagram relevant portions of a computing device (system) 60 in accordance with the invention. This is, e.g., a computer, mobile telephone, Smart Phone, personal digital assistant or similar device, or part of such a device and includes conventional hardware components executing in one embodiment software (computer code) as in the above example. This code may be coded, e.g., in the C or C++ computer language or its functionality may be expressed in the form of firmware or hardware logic; writing such code or designing such logic would be routine in light of the above example. Of course, the above example is not limiting.

The computer code is conventionally stored in code memory (computer readable storage medium, e.g., ROM) 90 (as object code or source code) associated with processor 64 for execution by processor 64. The incoming message to be hashed is received at port 92 and stored in computer readable storage medium (memory, e.g., RAM) 94 where it is coupled to processor 64. Processor 64 typically and conventionally pads and then partitions the message into suitable sized blocks as described above at partitioning module (logic) 96. Other software (code) modules executed in processor 64 include the R and T operations module (logic) 98 which carries out the R operation and T operation functionality set forth above.

Also coupled to processor 64 is the state readable storage medium (memory) 102, as well as a third storage 106 for the resulting hash digest. Storage locations 94, 102, 106 may be in one or several conventional physical memory devices (such as semiconductor RAM or its variants or a hard disk drive).

Electric signals conventionally are carried between the various elements of FIG. 3. Not shown in FIG. 3 is the subsequent conventional use of the resulting hash digest, which is compared by processor 64 to a second expected hash value associated with the message. Only if the two hash values match is the message (a digital document, digital signature or similar information) authenticated.

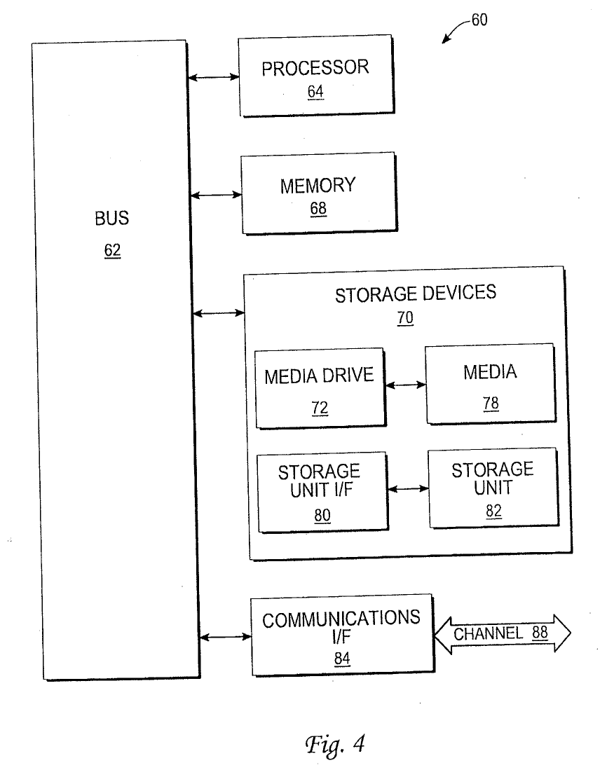

FIG. 4 shows further detail of the computing device 60 in one embodiment. FIG. 4 illustrates a typical and conventional computing system 60 that may be employed to implement processing functionality in embodiments of the invention and shows additional detail of the FIG. 3 system 60. Computing systems of this type may be used in a computer server or user (client) computer or other computing device, for example. Those skilled in the relevant art will also recognize how to implement embodiments of the invention using other computer systems or architectures. Computing system 60 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 60 can include one or more processors, such as a processor 64 (equivalent to processor 64 in FIG. 2). Processor 64 can be implemented using a general or special purpose processing engine such as, for example, a microprocessor, microcontroller or other control logic. In this example, processor 64 is connected to a bus 62 or other communications medium.

Computing system 60 can also include a main memory 68 (equivalent to memories 94, 102, 106), such as random access memory (RAM) or other dynamic memory, for storing information and instructions to be executed by processor 64. Main memory 68 also may be used for storing temporary variables or other intermediate information during execution of instructions to be executed by processor 64. Computing system 60 may likewise include a read only memory (ROM) or other static storage device coupled to bus 62 for storing static information and instructions for processor 64.

Computing system 60 may also include information storage system 70, which may include, for example, a media drive 62 and a removable storage interface 80. The media drive 72 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 78 may include, for example, a hard disk, floppy disk, magnetic tape, optical disk, CD or DVD, or other fixed or removable medium that is read by and written to by media drive 72. As these examples illustrate, the storage media 78 may include a computer-readable storage medium having stored therein particular computer software or data.

In alternative embodiments, information storage system 70 may include other similar components for allowing computer programs or other instructions or data to be loaded into computing system 60. Such components may include, for example, a removable storage unit 82 and an interface 80, such as a program cartridge and cartridge interface, a removable memory (for example, a flash memory or other removable memory module) and memory slot, and other removable storage units 82 and interfaces 80 that allow software and data to be transferred from the removable storage unit 78 to computing system 60.

Computing system 60 can also include a communications interface 84 (equivalent to port 92 in FIG. 2). Communications interface 84 can be used to allow software and data to be transferred between computing system 60 and external devices. Examples of communications interface 84 can include a modem, a network interface (such as an Ethernet or other network interface card (NIC)), a communications port (such as for example, a USB port), a PCMCIA slot and card, etc. Software and data transferred via communications interface 84 are in the form of signals which can be electronic, electromagnetic, optical or other signals capable of being received by communications interface 84. These signals are provided to communications interface 84 via a channel 88. This channel 88 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 68, storage device 78, or storage unit 82. These and other forms of computer-readable media may store one or more instructions for use by processor 64, to cause the processor to perform specified operations. Such instructions, generally referred to as “computer program code” (which may be grouped in the form of computer programs or other groupings), when executed, enable the computing system 60 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 60 using, for example, removable storage drive 74, drive 72 or communications interface 84. The control logic (in this example, software instructions or computer program code), when executed by the processor 64, causes the processor 64 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A hashing method performed by a computing apparatus and comprising the acts of:
(a) receiving a message at an input port;
(b) storing the received message in a first computer readable storage medium coupled to the input port;
(c) partitioning the stored message into portions;
(d) providing an initial value of a state of a quasi-group operation;
(e) applying the state and a portion of the message to the quasi-group operation and storing the resulting state in a second computer readable storage medium;
(f) repeating act (e) for a plurality of the portions of the message;
(g) applying a quasi-group operation at least once to the resulting state from act (f);
(h) extracting from the state resulting from act (g) a hash value of the message; and
(i) the processor storing the hash value in a third computer readable storage medium.

2. The method of claim 1, wherein the quasi-group operation of act (d) includes applying a plurality of bit rotations and exclusive OR operators.

3. The method of claim 1, wherein the quasi-group operation of act (d) is the R operation of the EDON-R hash function.

4. The method of claim 1, wherein the quasi-group operation of act (d) is a double pipe.

5. The method of claim 1, wherein the hash value is 256 to 512 bits long.

6. The method of claim 1, wherein act (c) includes padding the message.

7. The method of claim 6, wherein the padding is at least 65 bits long.

8. The method of claim 6, wherein a length of the padding is predetermined.

9. The method of claim 1, further comprising providing a parameter and performing act (g) a number of times defined by the parameter.

10. The method of claim 1, wherein the quasi-group operation of act (g) is the R operation of the EDON-R hash function.

11. The method of claim 1, wherein the quasi-group operations of acts (d) and (g) are not identical.

12. The method of claim 1, wherein the quasi-group operation of act (g) includes altering the state prior to applying the quasi-group operation.

13. The method of claim 1, further comprising the acts of:
receiving a hash value associated with the message at the processor;
comparing the received hash value to the stored hash value of act (i); and
authenticating the message if the comparison indicates a match.

14. The method of claim 1, wherein the message is one of a digital signature, a digital document, a digital message, a secret key or an identifier.

15. A computer readable medium storing computer code instructions for executing the method of claim 1 on the computing apparatus.

16. Apparatus for computing a hash, comprising:
(a) an input port for receiving a message;
(b) a first computer readable storage medium coupled to the input port for storing the received message; and
(c) a processor coupled to the first storage medium and which partitions the stored message into portions;
(d) the processor providing an initial value of a state of a quasi-group operation;
(e) wherein the processor applies the state and a portion of the message to the quasi-group operation and stores the resulting state in a second computer readable medium;
(f) wherein the processor repeats (e) for a plurality of portions of the message;
(g) wherein the processor applies a quasi-group operation at least once to the resulting state from (f);
(h) wherein the processor extracts from the state resulting from (g) a hash value of the message; and
(i) wherein the processor stores the hash value in a third computer readable storage medium coupled to the processor.

17. The apparatus of claim 16, wherein the quasi-group operation of (d) includes applying a plurality of bit rotations and exclusive OR operators.

18. The apparatus of claim 16, wherein the quasi-group operation of (d) is the R operation of the EDON-R hash function.

19. The apparatus of claim 16, wherein the quasi-group operation of (d) is a double pipe.

20. The apparatus of claim 16, wherein the hash value is 256 to 512 bits long.

21. The apparatus of claim 16, wherein (c) includes padding the message.

22. The apparatus of claim 21, wherein the padding is at least 65 bits long.

23. The apparatus of claim 21, wherein a length of the padding is predetermined.

24. The apparatus of claim 16, wherein the processor provides a parameter and performs (g) a number of times defined by the parameter.

25. The apparatus of claim 16, wherein the quasi-group operation of (g) is the R operation of the EDON-R hash function.

26. The apparatus of claim 16, wherein the quasi-group operations of (d) and (g) are not identical.

27. The apparatus of claim 16, wherein the quasi-group operation of (g) includes altering the state prior to applying the quasi-group operation.

28. The apparatus of claim 16, further comprising:
the processor receiving from the port a hash value associated with the message;
the processor comparing the received hash value to the stored hash value of (i) and authenticating the message if the comparison indicates a match.

29. The apparatus of claim 16, wherein the message is one of a digital signature, a digital document, a digital message, a secret key or an identifier.
